(19) United States
(12) Patent Application Publication
(10) Pub. No.: US 2020/0175445 A1
(43) Pub. Date: Jun. 4, 2020

(54) PROCESS DATA QUALITY AND RELIABILITY MANAGEMENT METHODOLOGY

(71) Applicant: Saudi Arabian Oil Company, Dhahran (SA)

(72) Inventors: Kokolu Rao Prabhakar, Dhahran (SA); Adeeb Hassan AlBukhari, Dhahran (SA)

(73) Assignee: Saudi Arabian Oil Company, Dhahran (SA)

(21) Appl. No.: 16/209,599

(22) Filed: Dec. 4, 2018

(51) Int. Cl. G06Q 10/06; G06Q 10/04

(52) U.S. Cl. CPC G06Q 10/06313; G06Q 10/04; G06Q 10/0635; G06Q 10/06393; G06Q 10/06395

(57) ABSTRACT

Methods, systems, and apparatus, including computer programs encoded on a computer storage medium, for improving efficiencies within an operational facility. In one aspect, a method includes receiving, from a data repository, system data that includes an abnormality, wherein the system data is collected from a plurality of systems deployed to service an operational facility; identifying the abnormality based on defined data quality measurements; assigning the abnormality to a category based on key performance indicators (KPIs) and the defined data quality measurements; determining a resolution to prevent the abnormality from occurring in subsequent system data based on the category assigned to the abnormality; and implementing the resolution in the systems deployed to service an operational facility.

### TECHNICAL FIELD

This disclosure relates to methods, systems, and apparatus for improving efficiencies within an operational facility.

### BACKGROUND

Many advanced industrial operations are dependent on information systems for control and analysis. Thus, process data is a valuable asset often of equal or even greater worth than physical assets. Moreover, considerable costs are often involved in collecting, storing, and acting upon this data in real-time. Additionally, as with physical assets, quality is a prerequisite for ensuring reliable operations. Accordingly, high data quality must be ensured to enable data reuse as well as provide for optimal data analytics on, for example, historical data. For example, information and analytics-driven organizations, with no traditional physical operational commitment, may rely solely on high quality data to compete in their respective market(s). Furthermore, digitalization in traditional industries may blur the boundary between traditional versus digital business operations. As a result, industry actors are moving toward partly or fully operating as information and analytics-driven organizations.

### SUMMARY

The present disclosure describes methods and systems, including computer-implemented methods, computer-program products, and computer systems for improving efficiencies by correcting and removing real-time process data abnormalities of systems within an operational facility.

In a general implementation, system data is received from a data repository. The system data includes an abnormality. The system data having been collected from a plurality of systems deployed to service an operational facility. The abnormality is identified based on defined data quality measurements. The abnormality is assigned to a category based on key performance indicators (KPIs) and the defined data quality measurements. A resolution is determined to prevent the abnormality from occurring in subsequent system data based on the category assigned to the abnormality. The resolution is implemented in the systems deployed to service an operational facility.

Implementations include a process data quality and reliability management methodology (PDQRMM) to increase the reliability of real-time data and decision within an operational facility through the improvement of various methods and systems for real-time data collection. For example, implementations of the methodology may increase the availability of operations real-time data thereby reducing unplanned downtime improving system performance, and load distribution and balancing. As another example, implementations of the methodology may improve the quality of real-time data by filtering noise, adjust data collection parameters to collect precise number of real-time data events and root cause analysis as well as provide for more consistent access to operational data by, for example, reducing data search times.

The details of one or more implementations of the subject matter of this specification are set forth in the accompanying drawings and the later description. Other features, aspects, and advantages of the subject matter will become apparent from the description, the drawings, and the claims.

### DESCRIPTION OF DRAWINGS

FIGS. 1 illustrates a block diagram of example of data flow to a data historian from systems for an enterprise and its operational facilities.

FIG. 2 illustrates a block diagram of an example system employing the PDQRMM.

FIG. 3 illustrates a flow diagram of an example of the PDQRMM.

FIG. 4 illustrates a block diagram of an exemplary computer system used to provide computational functionalities associated with described algorithms, methods, functions, processes, flows, and procedures as described in the instant disclosure, according to an implementation.

### DETAILED DESCRIPTION

This disclosure generally describes an optimization methodology for improving the reliability and efficiency of data being collected within an operational facility, an enterprise with multiple operational facilities, or both. The disclosure is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

Within an operating facility, such as a refinery, a real-time data value chain may be employed in both production and business operations. Within a data value chain, data is created, follows the appointed value chain(s), and is then refined, prepared for various tasks, or both. A system employing such data may not necessarily have knowledge of the origin of the data origin, the quality level or weaknesses of the data, legal or contractual obligations associated with the data, semantics within the data, changes in the system capturing or generating the data, the context in which the data was created, and so forth.

In order to ensure both reliable operations and valid analytics, data quality is assessed and may be continuously monitored for critical systems and services within an operating facility. Furthermore, data quality policies may be defined and processes put in place to support these policies. Within such policies, both requirements and set definition may be defined such that measurement points may be implemented to verify compliance with requirements. Additionally, such measures may be employed across an entire organization and within each of its operation facility to both ensure optimization and avoid quality assessment performed in silos.

To store the generated and captured real-time data an operational or data historian may be employed within an organization. A data historian is a database software application that logs or historizes, for example, time-based real-time process data. Data historian software may be employed to record trends and historical information about industrial processes with a respective organization. The data historian software may capture operational facility management information regarding, for example, production status, performance monitoring, quality assurance, tracking and genealogy, and product delivery. Data historian software may also provide more advance capabilities, such as, enhanced data capture, data compression, and data presentation.

In view of the forgoing, the described system employs a PDQRMM to, for example, improve the reliability of data being collected; compression efficiency, such as remove losses; or both. The PDQRMM is the conception, development, and execution of methods, architectures, policies, practices, and procedures to manage the real-time (time series) information lifecycle needs of an enterprise, its operational facilities in an effective and efficient manner, or both. The PDQRMM may be employed to monitor data quality by detecting data gaps, bad quality data, and other data faults leading to data degradation. Once detected, the PDQRMM determines and implements solutions for these detected abnormalities until satisfactory levels of data quality are reached.

For example, the portfolio of datasets or data repositories employed within, for example, a data historian, may be governed by an asset management system, with data quality management incorporated as a part of that system. Further, such an asset management system for data may be part of an enterprise wide asset management, which is often called governance level. An enterprise wide asset management may be employed to, for example, coordinate activities and define goals and risk tolerances, in order to realize value from information as an asset. Within such systems, the PDQRMM measures KPIs such as highly compressed data, unusable data, and discontinuous data, which reflect the quality and reliability of data collected in real-time. In some implementations, the PDQRMM identifies abnormalities in data employed within an operational facility, such as, incorrectly tuned parameters, gaps in generated data, and data loss due to, for example, high data compression. Once the abnormalities are identified, the described system employs respective solutions, which, for example, mitigate or stop data decay, improve the quality of collected data, adjust collection parameters, and optimize resources.

In some implementations, the methodology defines and implements data collection and data governing methods in real-time for data historian systems employed in, for example, an operating facility. The defined methods may focus on the quality and reliability of archiving in real-time time series data. For example, these defined methods may implement root cause analysis of the collected data, determine how to correct abnormal data conditions, or both.

In some implementations, the PDQRMM is employed to tune archive tuning parameters within, for example, a data historian employed within an operational facility. These parameters may include specifications regarding, for example, compression, filtering, exception reporting, scan rates, and minimum and maximum collection limits. Moreover, when changes are implemented in key systems employed in an operational facility, such as distributed control systems (DCS) or supervisory control and data acquisition (SCADA) systems, and so forth, errors, quality issues, or both may manifest within collected real-time time series data. In such scenarios, the PDQRMM may be employed to tune or alter parameters within the relevant data collection systems. By implementing these tuned parameters, inefficiencies in, for example, data collection, are reduced and data validity and accuracy are increased.

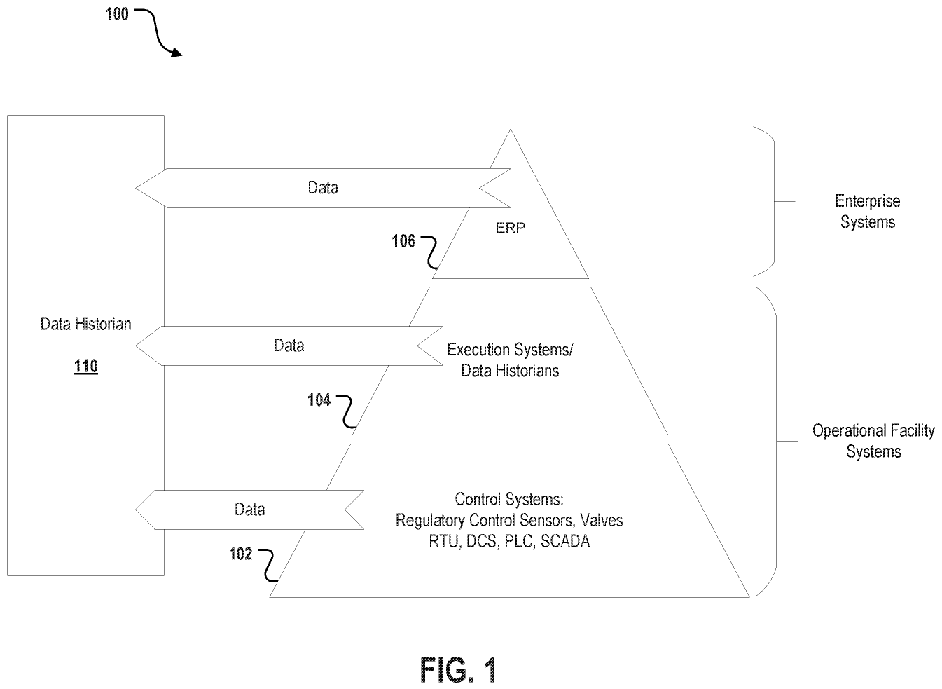

FIG. 1 illustrates a block diagram of example of data flow to a data historian from systems for an enterprise and its operational facilities. Hierarchy 100 includes control systems 102, execution systems 104 and enterprise resource planning (ERP) systems 106. Together, control level systems 102, execution systems 104 make up the systems employed with an operational facility, while ERP system 106 represent higher, enterprise wide systems. Control level systems 102 may include, for example, regulatory control sensors, valves, DCSs, programmable logic controllers (PLCs), remote terminal units (RTUs), and SCADA, along with data historians, that each collect and display data in various formats, and each solution has a distinct role in the respective operational facility. In some implementations, control level systems 102 primarily focused on controlling, for example, manufacturing and production equipment. DCS and SCADA systems may use proportional-integral-derivative (PID) loops to control performance, while PLCs may use ladder logic. Each of these systems may be equipped with human machine interfaces (HMI) that allow an operator to monitor the process and intervene when an abnormal conditions occurs. DCS, SCADA, and PLC systems may also provide a view of information from within their own respective system.

DCSs are automated control systems that are employed to manage operations within an operational facility or control area at a given moment in time. Within a DCS, each process element, machine, or group of machines may be controlled by a dedicated controller. DCS may also include a number of local controllers in various sections of an operational facility or a control area that are connected through a high speed communication network. In some implementations, a DCS provides for process control, such as making adjustments to control valves, actuators, or both. Certain DCSs may include an HMI that provides graphics, trends, and alarms that allows operators to supervise a process.

PLCs and RTUs are microcomputers, control systems, or both that, for example, communicate with an array of objects such as facility machines, HMIs, sensors, and end devices, and then route the information from those objects to computers with SCADA software. PLCs may continuously monitor the state of input devices, such as digital sensors, and make decisions based upon a custom program to control the state of output devices. RTUs may interface objects in the physical world to a distributed control system or SCADA by transmitting telemetry data to a master system, and by using messages from the master supervisory.

SCADA are systems of software and hardware elements that may be employed for process control in, for example, smaller applications. These systems may handle management of a respective operational facility. An SCADA architecture may include PLC, RTUs, or both. The SCADA software processes, distributes, and displays data, helping operators and other employees analyze the data and make important decisions. For example, the SCADA system quickly notifies an operator that a batch of product is showing a high incidence of errors. The operator pauses the operation and views the SCADA system data via an HMI to determine the cause of the issue. The operator reviews the data and discovers that Machine 4 was malfunctioning. The SCADA system's ability to notify the operator of an issue helps him to resolve it and prevent further loss of product.

An execution system 104 is a comprehensive system that controls the activities occurring within a respective operational facility. In some implementations, an execution system 104 connects, monitors, and controls complex systems as well as data flow within a respective operational facility. Such systems may be designed to, for example, ensure effective execution of the operations and improve production output. Moreover, an execution system 104 may operate across multiple function areas, such as management of product definitions across the product life-cycle, resource scheduling, order execution and dispatch, production analysis, and downtime management for overall equipment effectiveness (OEE), Product Quality, or materials track and trace. In some implementations, the execution system 104 creates an “as-built” record, captures data, processes, and determines outcomes of an overall process.

ERP systems 106 includes business-management software or a suite of integrated applications that an enterprise can employ to collect and interpret data from business activities. In some implementations, ERP systems 106 integrated management of core business processes, often in real-time, and mediated by software and technology. ERP systems 106 may also provide an integrated and continuously updated view of core business processes using common databases maintained by a database management system. Furthermore, ERP systems 106 may track business resources, such as raw materials and production capacity, and the status of business commitments, such as orders, purchase orders, and payroll.

Information from each of these systems, 102, 104, and 106, may be fed information into a data repository, such as data historian 110. The data historian 110 (also known as a process historian or operational historian) is a system that records and retrieves production and process data by time. Data historian 100 may store information in a time series database, which efficiently stores the received data with minimal disk space, fast retrieval, or both. In some implementations, this time series information is often displayed in a trend or as tabular data over a time range, such as the last day, last 8 hours, or last year. The data historian 110 may store information generated by systems within an operational facility, enterprise, or both, such as recorded instrument readings; process data, such as flow rate, valve position, vessel level, temperature, or pressure; status, such as machine up or down or downtime reason tracking; performance monitoring, such as units or hour, machine utilization versus machine capacity, or scheduled versus unscheduled outages; quality control, such as quality readings inline or offline for compliance to specifications; or cost, such as machine and material costs assignable to a production. Additionally, the data historian 110 may record data over time from one or more locations for analysis.

In addition, the advanced analytical capabilities of the data historian 110 allow operators to gain a deep understanding of a process, its variability, and how it can be improved. The data historians 110 may be deployed as a single operational facility system, but may also be configured as “enterprise historians” that pull information from data historians deployed to other operational facilities or function as a lead historian obtaining information directly from each operational facility directly. Either of these configurations enables enterprise-wide benchmarking to further optimize process.

In some implementations, data historian 110 may be functionally implemented through a suite of systems, applications, or both, such as Process Intelligence (PI) system™, that are employed for data collection, historicizing, finding, analyzing, delivering, and visualizing, of real-time data and events. In such systems, tags may be employed. In some implementations, a tag is a unique storage place for a specific stream of data.

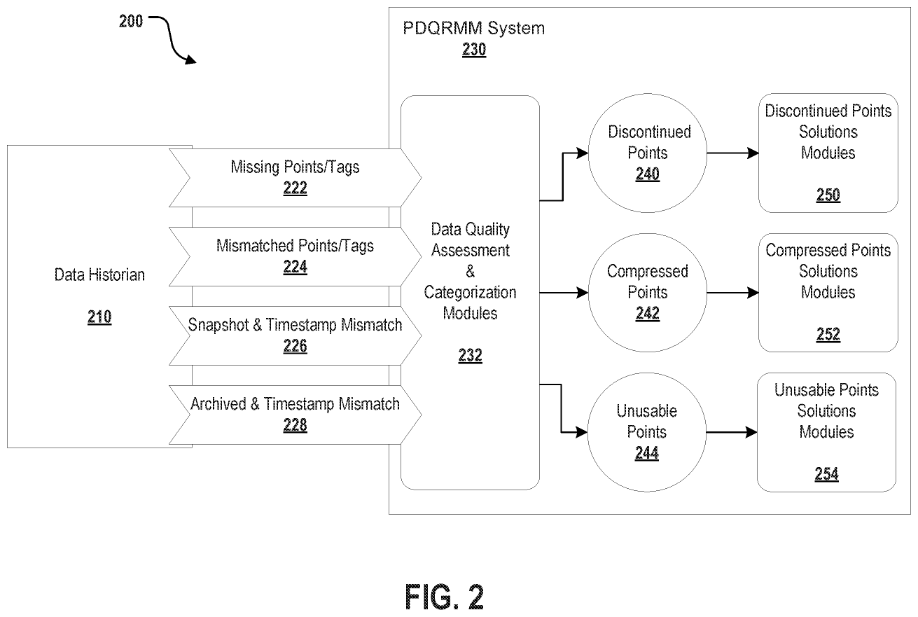

FIG. 2 illustrates a block diagram of an example system 200 employing the PDQRMM. FIG. 2 includes data historian 210 and an example system employing the describe PDQRMM 230. The PDQRMM system 230 includes data quality assessment and categorization modules 232, discontinued points solutions module 250, compressed points solutions module 252, and unusable points solutions modules 254. Data historian 110 is substantially similar to data historian and stores information received from an enterprise and its operational facilities employing the PDQRMM.

The data quality assessment and categorization modules 232 receives, pulls, or both stored data from the data historian 210 that may include abnormalities. Such abnormalities may include, as depicted, missing points or tags 222, mismatched points or tags 224, snapshot value and timestamp mismatch 226, and archived value and timestamp mismatch 228. The depicted abnormalities are examples as other abnormalities, as discussed in detail later, may be included in the data stored in the data historian 210.

The data quality assessment and categorization modules 232 perform a data quality assessment from the data stored in data history 210. In some implementations, the data quality assessment is a method to verify that the stored data meets the implicit or explicit expectations of users or systems within an enterprise that are employing the data. The assessment of data quality with the quality assessment and categorization modules 232 as a part of the PDQRMM may include assigning a score that indicates how the data meets these expectations. For example, a score value may be assigned that is indicative of the data quality of the stored data proportional to a threshold. Additionally, assessments of data quality-related processes and capabilities may be measured as organizational maturity according to a set of criteria. These two different measurements, such as the score and assigned maturity, may be used as inputs to determine risk and ultimately ways to improve the quality of the collected data, within the PDQRMM system 230. Additionally, assessments of risk within the PDQRMM may use these measurements as input for obtaining a picture of the risk of usages of the collected data in various systems, enterprise units, or both. Measured and documented data quality and maturity levels, within risk tolerance thresholds, are viewed as prerequisites to safe, sustainable, and efficient enterprise operations.

Data quality within, for example, data historian 210, may be impacted greatly by tuning parameters, such as tags. Examples of such parameters may include compression specifications, filtering, exception reporting, scan rates, zero and span. Accordingly, the PDQRMM may be employed within an enterprise to health-check existing information stored within a data historian(s) to, for example, discover and resolve prevailing abnormalities and abnormalities, such as missing points or tags 222, mismatched points or tags 224, snapshot value and timestamp mismatch 226, and archived value and timestamp mismatch 228, according to metrics, defined criteria, or both. In some implementations, the data quality assessment and categorization modules 232 may define various types of data quality including excessive filtering, no longer collected data, unusable data, or both.

In some implementations, the quality assessment and categorization modules 232 through the use of the PDQRMM may define categories for data quality measurements, such as, syntactic, semantic, and pragmatic. These categories are employed to provide a foundation for measuring information and data quality. Syntactic measurements may describe the degree to which data conforms to a specified syntax, such as requirements stated by the metadata. Semantic measurements may describe the degree to which data corresponds with that which it represents, such as when a sensor measures 72° C. or the actual temperature should also be 72° C. at the point of measurement. Pragmatic measurements may describe the degree to which data is appropriate and useful for a particular purpose.

In some implementations, the quality assessment and categorization modules 232, also implement a data quality maturity framework to assist in the categorization of detected abnormalities. This framework includes elements, maturity levels, and evaluation criteria. The elements describe governance, processes, technologies, capabilities, and activities that may be implemented to support data quality. Detailed evaluation criteria are given for each framework element at an assigned maturity level for the enterprise. The assigned maturity level provides a measuring device for the elements, and the data quality assessments provide a way to verify and validate datasets. Though there is no 1:1 correlation between an assigned maturity and data quality, and an enterprise could have a high score for maturity and a low one for data quality, or vice versa. However, high maturity levels are often associated with high data quality.

For example, a maturity level may be determined for enterprises collecting, using, and sharing data, within, for example, a data historian, in order to assess the reliability of the data and the ability to respond to data quality incidents in a predictable and repeatable manner. Additionally, an enterprise may define data quality requirements, data standards and governance and communication channels. In some implementations, data quality can be measured according to a standard, such as International Standards Organization (ISO) 8000-8. Moreover, data quality can improve continuously through feedback processes, change management, or both. For example, information security may be tightly coupled to data quality and each of the main elements of information security, availability, confidentiality, and integrity, may affect elements of data quality. Additionally, a high level of assigned maturity of data quality may indicate higher levels of information security.

As depicted in FIG. 2, the quality assessment and categorization modules 232 categorize various abnormalities detected in the received data. FIG. 2 depicts 3 categories of abnormal data points, tags, or both: discontinued points or tags 240, compressed points or tags 242, and unusable points or tags 244; however, other categories may be used depending on, for example, the type of enterprise, the purpose of each operational facility, or both.

The discontinued points category 240 may include data gaps, out of range points, and data with timestamp discrepancies. Collection of these points or tags may be intermittently failing and thus create gaps in the data. Other types of data in this category may include data with missing or inaccurate timestamp information as well as data collected outside of an instrument range, such as an out of range points. Additionally, data points or tags with too little or no filter settings, scan rates, or both that do not meet a set threshold, such as fast points, may also be included. Fast points or tags are when a large number of data points are collected, many of which are repeated values. Such points can overload the system. Other included data points may be points that are soon to be dead if no action is taken. Discontinued data points, for example, use up bandwidth and exacerbate network failures. Once categorized, the discontinued points solutions modules 250 may recommend and implement solutions to address these points quickly because, for example, third-party applications that depend on this data would be reporting wrong information, misleading information, or both to users. The identification and fixing of these discontinued points may improve the data reliability and quality.

The compressed points category 242 includes points with high or no filtering and ranges that are outside of a defined threshold based on, for example, a collecting instrument's measuring capabilities. These tags are indicative that a large number of events are being lost, which can result in data loss as the ranges are considered by, for example, the data historians while setting data compressions. Once categorized, the compressed points solutions modules 252 may verify and tune these parameters. In some implementations, tuning filtering parameters avoids sending changes that are smaller than an instrument can measure, for example, from a DCS or SCADA to the collecting server. The redefined filtering range may act as a deadband, which may be employed to determine whether to send events to, for example, another system. In some implementations, a system interface may ignore values that fall inside the deadband. Similarly, the retuned parameters may also enable the removal of unnecessary data, increased efficiencies in archive storage, or both.

The unusable points category 244 may include bad, such has unusable; dead, such as no longer collected; or stale, such as have not been collected since creation, data points or tags. Stale data may be identified according to a set threshold, such as one year. Some types of data collection points may be exempted or given leniency as some might not change frequently. Once identified, such data points or tags may overload systems and consume licenses. The unusable points solution modules 254 may remove or release these points or revise their collection in some way, which allow for increased reuse and improve the performance of the respective data historian.

Once solutions are determined by the solutions modules 250-254, the PDQRMM system 230 may then report and implement different methods of fixing or exploiting these data conditions. Example solutions may include removing unusable tags, reducing high compressions for identified tags, verifying out of range data points or tags, or deleting identified dead and bad data points or tags. In some implementations, the solution modules 250-254 may also review and configure the default attributes for ranges, and their associated instruments measuring ranges based on the determined and categorized abnormal data points or tags. In some implementations, the example solutions may include reconfiguring tags identified with high compression as such attributes may result in data loss. For example, when an archive is uncompressed, lossless compression may enable the restoration of archived data to an original state, without the loss of data. Other solutions may also include reconfiguring tags identified with compression turned off to reduce the amounts of replicated data and put less demand on network traffic. As an example, the discontinued points solution module 250, may troubleshoot and fix tags that are identified as discontinued 240. Such discontinued tags, such as stale tags, out of range tags, digital failed tags, and fast tags, may not, for example, continually collect streams of data or may be intermitted, such as failed to collect good data or have data gaps, for more than a threshold period of time.

As used herein, the term “real-time” refers to transmitting or processing data without intentional delay given the processing limitations of a system, the time required to accurately obtain data and images, and the rate of change of the data and images. In some examples, “real-time” is used to describe the categorization of abnormalities from a data historian, such as data historians 110 and 210, as well as the determination of a solution by a system employing the PDQRMM, such as PDQRMM system 230.

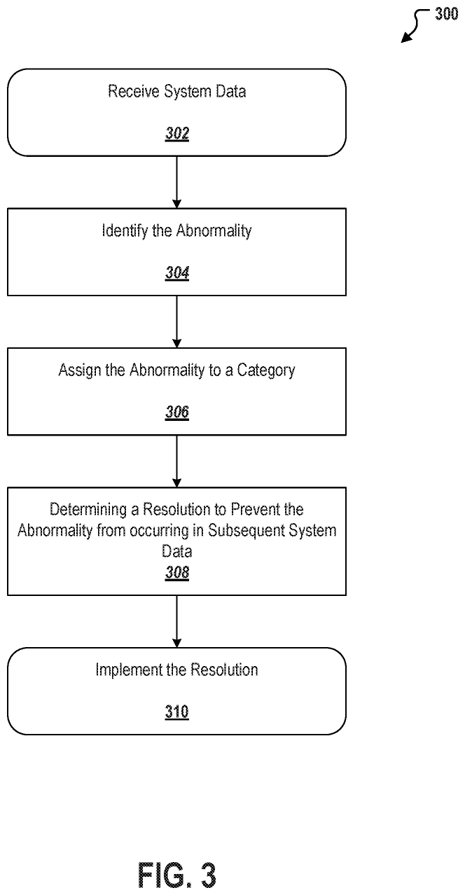

FIG. 3 illustrates a flow diagram of an example of the PDQRMM. For clarity of presentation, the description that follows generally describes method 300 in the context of FIGS. 1, 2, and 4. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, or in any order.

At 302, system data from a data repository, such as a data historian, is received. The system data includes an abnormality and is collected from systems deployed to service an operational facility, such as a refinery. As described earlier in FIG. 1, these systems may include DCSs, PLCs, RTUs, SCADA, execution systems, and ERP systems. The abnormality may include, for example a missing data point, a mismatched data point, a snapshot value and timestamp mismatch, an archived value and timestamp mismatch, a data gap, data loss dues to data compression, or poor quality data due to an incorrectly tuned parameter. From 302, the process 300 proceeds to 304.

At 304, the abnormality is identified base on defined data quality measurements, such as syntactic, semantic, and pragmatic categories. From 304, the process 300 proceeds to 306.

At 306, the abnormality is assigned to a category based on KPIs and the defined data quality measurements. By way of example, the assigned category may be compressed data, unusable data, or discontinuous data as described earlier in FIG. 2. From 306, the process 300 proceeds to 308.

At 308, a resolution to prevent the abnormality from occurring in subsequent system data is determined based on the KPI category assigned to the abnormality. Additionally, the resolution may be further determined based on an assessment of risk for the operational facility and the system data. The assessment of risk is determined based on a score value assigned to the system data and an organizational maturity assigned to the for the operational facility, the systems that collected the stored data, or both. The organizational maturity is assigned based on an assessment of data quality-related processes and capabilities of the operational facility, while the score value is indicative of a level of quality of the system data respective to a threshold and is assigned to the system data based on an assessment of the system data. From 308, the process 300 proceeds to 310.

At 310, the resolution is implemented in the systems deployed to service the operational facility. The resolution may include tuning data collection parameters within the deployed to systems. The data collection parameters may include, for example, compression specifications, filtering, or exception reporting. The resolution may, for example, mitigate data decay, adjusts collection parameters, or optimizes resources within the deployed to systems. From 310, the process 300 ends.

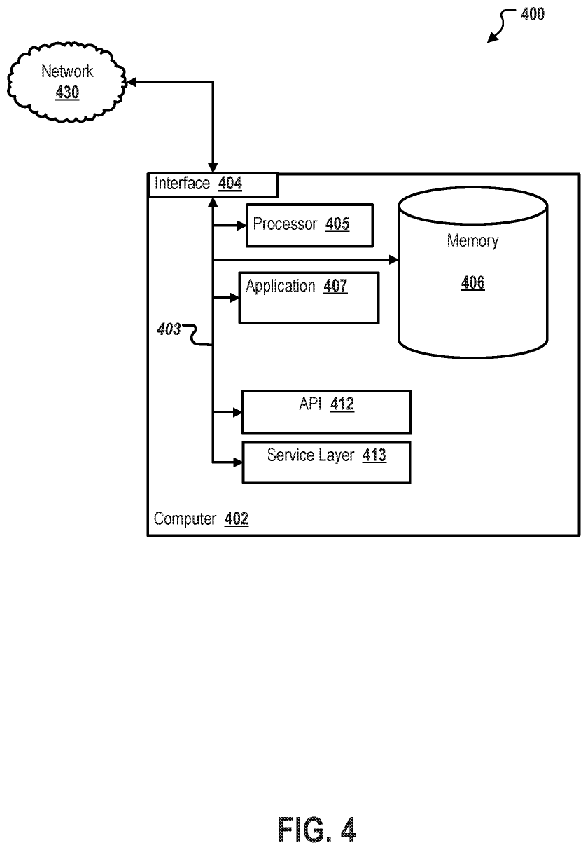

FIG. 4 illustrates a block diagram of an exemplary computer system 400 used to provide computational functionalities associated with described algorithms, methods, functions, processes, flows, and procedures as described in the instant disclosure, according to an implementation. The illustrated computer 402 is intended to encompass any computing device such as a server, desktop computer, laptop or notebook computer, wireless data port, smart phone, personal data assistant (PDA), tablet computing device, one or more processors within these devices, or any other suitable processing device, including both physical or virtual instances (or both) of the computing device. Additionally, the computer 402 may comprise a computer that includes an input device, such as a keypad, keyboard, touch screen, or other device that can accept user information, and an output device that conveys information associated with the operation of the computer 402, including digital data, visual, or audio information (or a combination of information), or a graphical user interface (GUI).

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, business intelligence (BI) server, or other server (or a combination of servers).

The computer 402 can receive requests over network 430 from a client application (for example, executing on another computer 402) and responding to the received requests by processing the said requests in an appropriate software application. In addition, requests may also be sent to the computer 402 from internal users (for example, from a command console or by other appropriate access method), external or third-parties, other automated applications, as well as any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an application programming interface (API) 412 or a service layer 413 (or a combination of the API 412 and service layer 413). The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined business functionalities through a defined interface. For example, the interface may be software written in JAVA, C++, or other suitable language providing data in extensible markup language (XML) format or other suitable format. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems in a distributed environment that are connected to the network 430 (whether illustrated or not). Generally, the interface 404 comprises logic encoded in software or hardware (or a combination of software and hardware) and operable to communicate with the network 430. More specifically, the interface 404 may comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors may be used according to particular needs, desires, or particular implementations of the computer 402. Generally, the processor 405 executes instructions and manipulates data to perform the operations of the computer 402 and any algorithms, methods, functions, processes, flows, and procedures as described in the instant disclosure.

The computer 402 also includes a memory 406 that holds data for the computer 402 or other components (or a combination of both) that can be connected to the network 430 (whether illustrated or not). For example, memory 406 can be a database storing data consistent with this disclosure. Although illustrated as a single memory 406 in FIG. 4, two or more memories may be used according to particular needs, desires, or particular implementations of the computer 402 and the described functionality. While memory 406 is illustrated as an integral component of the computer 402, in alternative implementations, memory 406 can be external to the computer 402.

The application 407 is an algorithmic software engine providing functionality according to particular needs, desires, or particular implementations of the computer 402, particularly with respect to functionality described in this disclosure. For example, application 407 can serve as one or more components, modules, applications, etc. Further, although illustrated as a single application 407, the application 407 may be implemented as multiple applications 407 on the computer 402. In addition, although illustrated as integral to the computer 402, in alternative implementations, the application 407 can be external to the computer 402.

There may be any number of computers 402 associated with, or external to, a computer system containing computer 402, each computer 402 communicating over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

Described implementations of the subject matter can include one or more features, alone or in combination.

For example, in a first implementation, a computer-implemented method executed by one or more processors includes receiving, from a data repository, system data that includes an abnormality, wherein the system data is collected from a plurality of systems deployed to service an operational facility; identifying the abnormality based on defined data quality measurements; assigning the abnormality to a category based on KPIs and the defined data quality measurements; determining a resolution to prevent the abnormality from occurring in subsequent system data based on the category assigned to the abnormality; and implementing the resolution in the systems deployed to service an operational facility

The foregoing and other described implementations can each optionally include one or more of the following features.

A first feature, combinable with any of the following features, the method includes performing a data quality assessment of the system data to verify that system data meets a threshold; assigning a score value to the system data based on the data quality assessment, the score value indicative of a level of quality of the system data respective to the threshold; assigning an organizational maturity to the operational facility based on an assessment of data quality-related processes and capabilities within the operational facility; and determine a risk assessment for the operational facility and the system data based on the score value and the organizational maturity, wherein the resolution is further determined based on the risk assessment.

A second feature, combinable with any of the previous or following features the abnormality is one of a missing data point, a mismatched data point, a snapshot value and timestamp mismatch, an archived value and timestamp mismatch, a data gap, data loss dues to data compression, or poor quality data due to an incorrectly tuned parameter.

A third feature, combinable with any of the previous or following features, the category is one of compressed data, unusable data, and discontinuous data.

A fourth feature, combinable with any of the previous or following features, the discontinued data includes data gaps, out of range data points, and data with timestamp discrepancies.

A fifth feature, combinable with any of the previous or following features, the compressed data includes data points with high or no filtering and data in ranges that are outside of a defined threshold of a collecting instrument measuring capability.

A sixth feature, combinable with any of the previous or following features, the unusable data category includes no longer collected or stale data points.

A seventh feature, combinable with any of the previous or following features, the defined data quality measurements include syntactic, semantic, and pragmatic categories.

An eighth feature, combinable with any of the previous or following features, the resolution includes tuning data collection parameters that include compression specifications, filtering, or exception reporting.

A ninth feature, combinable with any of the previous or following features, the operational facility is a refinery.

A tenth feature, combinable with any of the previous or following features, the data repository is a data historian.

An eleventh feature, combinable with any of the previous or following features, the systems deployed to service an operational facility include DCSs, PLCs, RTUs, SCADA, execution systems, and enterprise resource planning ERP systems.

In a second implementation, one or more non-transitory computer-readable storage media coupled to one or more processors and having instructions stored thereon which, when executed by the one or more processors, cause the one or more processors to perform operations that include receiving, from a data repository, system data that includes an abnormality, wherein the system data is collected from a plurality of systems deployed to service an operational facility; identifying the abnormality based on defined data quality measurements; assigning the abnormality to a category based on KPIs and the defined data quality measurements; determining a resolution to prevent the abnormality from occurring in subsequent system data based on the category assigned to the abnormality; and implementing the resolution in the systems deployed to service an operational facility

The foregoing and other described implementations can each optionally include one or more of the following features.

A first feature, combinable with any of the following features, the operations include performing a data quality assessment of the system data to verify that system data meets a threshold; assigning a score value to the system data based on the data quality assessment, the score value indicative of a level of quality of the system data respective to the threshold; assigning an organizational maturity to the operational facility based on an assessment of data quality-related processes and capabilities within the operational facility; and determine a risk assessment for the operational facility and the system data based on the score value and the organizational maturity, wherein the resolution is further determined based on the risk assessment.

A second feature, combinable with any of the previous or following features the abnormality is one of a missing data point, a mismatched data point, a snapshot value and timestamp mismatch, an archived value and timestamp mismatch, a data gap, data loss dues to data compression, or poor quality data due to an incorrectly tuned parameter.

A third feature, combinable with any of the previous or following features, the category is one of compressed data, unusable data, and discontinuous data.

A fourth feature, combinable with any of the previous or following features, the discontinued data includes data gaps, out of range data points, and data with timestamp discrepancies.

A fifth feature, combinable with any of the previous or following features, the compressed data includes data points with high or no filtering and data in ranges that are outside of a defined threshold of a collecting instrument measuring capability.

A sixth feature, combinable with any of the previous or following features, the unusable data category includes no longer collected or stale data points.

A seventh feature, combinable with any of the previous or following features, the defined data quality measurements include syntactic, semantic, and pragmatic categories.

An eighth feature, combinable with any of the previous or following features, the resolution includes tuning data collection parameters that include compression specifications, filtering, or exception reporting.

A ninth feature, combinable with any of the previous or following features, the operational facility is a refinery.

A tenth feature, combinable with any of the previous or following features, the data repository is a data historian.

An eleventh feature, combinable with any of the previous or following features, the systems deployed to service an operational facility include DCSs, PLCs, RTUs, SCADA, execution systems, and enterprise resource planning ERP systems.

In a third implementation, a computer-implemented system, comprising: one or more processors; and a computer-readable storage device coupled to the one or more processors and having instructions stored thereon which, when executed by the one or more processors, cause the one or more processors to perform operations that include receiving, from a data repository, system data that includes an abnormality, wherein the system data is collected from a plurality of systems deployed to service an operational facility; identifying the abnormality based on defined data quality measurements; assigning the abnormality to a category based on KPIs and the defined data quality measurements; determining a resolution to prevent the abnormality from occurring in subsequent system data based on the category assigned to the abnormality; and implementing the resolution in the systems deployed to service an operational facility

The foregoing and other described implementations can each optionally include one or more of the following features.

A first feature, combinable with any of the following features, the operations include performing a data quality assessment of the system data to verify that system data meets a threshold; assigning a score value to the system data based on the data quality assessment, the score value indicative of a level of quality of the system data respective to the threshold; assigning an organizational maturity to the operational facility based on an assessment of data quality-related processes and capabilities within the operational facility; and determine a risk assessment for the operational facility and the system data based on the score value and the organizational maturity, wherein the resolution is further determined based on the risk assessment.

A second feature, combinable with any of the previous or following features the abnormality is one of a missing data point, a mismatched data point, a snapshot value and timestamp mismatch, an archived value and timestamp mismatch, a data gap, data loss dues to data compression, or poor quality data due to an incorrectly tuned parameter.

A third feature, combinable with any of the previous or following features, the category is one of compressed data, unusable data, and discontinuous data.

A fourth feature, combinable with any of the previous or following features, the discontinued data includes data gaps, out of range data points, and data with timestamp discrepancies.

A fifth feature, combinable with any of the previous or following features, the compressed data includes data points with high or no filtering and data in ranges that are outside of a defined threshold of a collecting instrument measuring capability.

A sixth feature, combinable with any of the previous or following features, the unusable data category includes no longer collected or stale data points.

A seventh feature, combinable with any of the previous or following features, the defined data quality measurements include syntactic, semantic, and pragmatic categories.

An eighth feature, combinable with any of the previous or following features, the resolution includes tuning data collection parameters that include compression specifications, filtering, or exception reporting.

A ninth feature, combinable with any of the previous or following features, the operational facility is a refinery.

A tenth feature, combinable with any of the previous or following features, the data repository is a data historian.

An eleventh feature, combinable with any of the previous or following features, the systems deployed to service an operational facility include DCSs, PLCs, RTUs, SCADA, execution systems, and enterprise resource planning ERP systems.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a PDA, a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and compact disc (CD)-ROM, digital versatile disc (DVD) +/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light-emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term GUI may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an API or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in XML format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described earlier as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products.

Accordingly, the earlier description of example implementations does not define or constrain this disclosure. Other changes, substitutions, and alterations are also possible without departing from the spirit and scope of this disclosure.

Furthermore, any claimed implementation later described is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method executed by one or more processors, the method comprising:
receiving, from a data repository, system data that includes an abnormality, wherein the system data is collected from a plurality of systems deployed to service an operational facility;
identifying the abnormality based on defined data quality measurements;
assigning the abnormality to a category based on key performance indicators (KPIs) and the defined data quality measurements;
determining a resolution to prevent the abnormality from occurring in subsequent system data based on the category assigned to the abnormality; and
implementing the resolution in the systems deployed to service an operational facility.

2. The method of claim 1, further comprising:
performing a data quality assessment of the system data to verify that system data meets a threshold;
assigning a score value to the system data based on the data quality assessment, the score value indicative of a level of quality of the system data respective to the threshold;
assigning an organizational maturity to the operational facility based on an assessment of data quality-related processes and capabilities within the operational facility; and
determine a risk assessment for the operational facility and the system data based on the score value and the organizational maturity, wherein the resolution is further determined based on the risk assessment.

3. The method of claim 1, wherein the abnormality is one of a missing data point, a mismatched data point, a snapshot value and timestamp mismatch, an archived value and timestamp mismatch, a data gap, data loss dues to data compression, or poor quality data due to an incorrectly tuned parameter.

4. The method of claim 1, wherein the category is one of compressed data, unusable data, and discontinuous data.

5. The method of claim 4, wherein the discontinued data includes data gaps, out of range data points, and data with timestamp discrepancies.

6. The method of claim 4, wherein the compressed data includes data points with high or no filtering and data in ranges that are outside of a defined threshold of a collecting instrument measuring capability.

7. The method of claim 4, wherein the unusable data category includes no longer collected or stale data points.

8. The method of claim 1, wherein the defined data quality measurements include syntactic, semantic, and pragmatic categories.

9. The method of claim 1, wherein the resolution includes tuning data collection parameters that include compression specifications, filtering, or exception reporting.

10. The method of claim 1, wherein the resolution mitigates data decay in the system data, adjusts collection parameters, or optimizes a resource.

11. The method of claim 1, wherein the operational facility is a refinery.

12. The method of claim 1, wherein the data repository is a data historian.

13. The method of claim 1, wherein the systems deployed to service an operational facility include distributed control systems (DCSs), programmable logic controllers (PLCs), remote terminal units (RTUs), supervisory control and data acquisition (SCADA), execution systems, and enterprise resource planning (ERP) systems.

14. One or more non-transitory computer-readable storage media coupled to one or more processors and having instructions stored thereon which, when executed by the one or more processors, cause the one or more processors to perform operations comprising:
receiving, from a data repository, system data that includes an abnormality, wherein the system data is collected from a plurality of systems deployed to service an operational facility;
identifying the abnormality based on defined data quality measurements;
assigning the abnormality to a category based on key performance indicators (KPIs) and the defined data quality measurements;
determining a resolution to prevent the abnormality from occurring in subsequent system data based on the category assigned to the abnormality; and
implementing the resolution in the systems deployed to service an operational facility.

15. The one or more non-transitory computer-readable storage media of claim 14, wherein the operations comprise:
performing a data quality assessment of the system data to verify that system data meets a threshold;
assigning a score value to the system data based on the data quality assessment, the score value indicative of a level of quality of the system data respective to the threshold;
assigning an organizational maturity to the operational facility based on an assessment of data quality-related processes and capabilities within the operational facility; and
determine a risk assessment for the operational facility and the system data based on the score value and the organizational maturity, wherein the resolution is further determined based on the risk assessment.

16. The one or more non-transitory computer-readable storage media of claim 14, wherein the abnormality is one of a missing data point, a mismatched data point, a snapshot value and timestamp mismatch, an archived value and timestamp mismatch, a data gap, data loss dues to data compression, or poor quality data due to an incorrectly tuned parameter.

17. A computer-implemented system, comprising:
one or more processors; and
a computer-readable storage device coupled to the one or more processors and having instructions stored thereon which, when executed by the one or more processors, cause the one or more processors to perform operations comprising:
receiving, from a data repository, system data that includes an abnormality, wherein the system data is collected from a plurality of systems deployed to service an operational facility;
identifying the abnormality based on defined data quality measurements;
assigning the abnormality to a category based on key performance indicators (KPIs) and the defined data quality measurements;
determining a resolution to prevent the abnormality from occurring in subsequent system data based on the category assigned to the abnormality; and
implementing the resolution in the systems deployed to service an operational facility.

18. The computer-implemented system of claim 17, wherein the category is one of compressed data, unusable data, and discontinuous data.

19. The computer-implemented system of claim 18, wherein the discontinued data includes data gaps, out of range data points, and data with timestamp discrepancies, wherein the compressed data includes data points with high or no filtering and data in ranges that are outside of a defined threshold of a collecting instrument measuring capability, and wherein the unusable data category includes no longer collected or stale data points.

20. The computer-implemented system of claim 17, wherein the resolution mitigates data decay in the system data, adjusts collection parameters, or optimizes a resource.
